(19) United States
(12) Patent Application Publication
(10) Pub. No.: US 2025/0132893 A1
(43) Pub. Date: Apr. 24, 2025

(54) GENERATION OF A MATRIX

(71) Applicant: STMicroelectronics International N.V., Geneva (CH)

(72) Inventors: Pierre-Alexandre BLANC, Evere (BE); Benjamin SARTORI, Koekelberg (BE)

(73) Assignee: STMicroelectronics International N.V., Geneva (CH)

(21) Appl. No.: 18/910,731

(22) Filed: Oct. 9, 2024

(30) Foreign Application Priority Data
Oct. 20, 2023 (FR) 2311368

(51) Int. Cl. H04L 9/06; G06F 7/58

(52) U.S. Cl. CPC H04L 9/0618; G06F 7/582

(57) ABSTRACT

The present description concerns a method of verification, implemented by an electronic device, of a matrix used for the implementation of a data cipher algorithm comprising, for the generation of the matrix, the use of a first function and of a second function, the verification method comprising a verification using a final portion of the output data of the first function.

### CROSS-REFERENCE TO RELATED APPLICATION(S)

This application claims the priority benefit of French patent application number FR2311368, filed on Oct. 20, 2023, entitled “Génération d'une matrice”, which is hereby incorporated by reference to the maximum extent allowable by law.

### BACKGROUND

### Technical Field

The present disclosure generally concerns electronic systems and devices, and more particularly the security of these systems and devices. The present disclosure relates, more particularly, to data ciphering methods, and to the verification of their implementations.

### Description of the Related Art

Different techniques or securing secret and/or critical data are currently used. Data cipher is one of them, and consists of the application of one or a plurality of encryption algorithms to data, such as critical data. Many encryption algorithms use matrices of data and/or polynomials.

In certain cases, these matrices are periodically generated, for example at each implementation of a data ciphering method. It may then be necessary to have to verify the generation of these matrices.

It would be desirable to be able to at least partly improve certain aspects of methods of verification and/or of error detection of the implementation of data ciphering methods.

### BRIEF SUMMARY

There exists a use for data ciphering methods using encryption matrices which have been duly verified.

There exists a use for data ciphering methods using lattices-based cryptography algorithms using encryption matrices which have been duly verified.

There exists a use for data ciphering methods using algorithms known under denomination “Kyber” using encryption matrices which have been duly verified.

There exists a use for data ciphering methods using algorithms known under denomination “CRYSTALS-Dilithium” using encryption matrices which have been duly verified.

An embodiment overcomes all or part of the disadvantages of known data ciphering methods.

An embodiment overcomes all or part of the disadvantages of known data signature methods.

An embodiment overcomes all or part of the disadvantages of known methods for verifying a matrix used for a data ciphering method.

An embodiment overcomes all or part of the disadvantages of known methods for verifying a matrix used for a data signature method.

An embodiment provides a method of verification of a matrix used for the signature of data using data generated during the generation of such a matrix.

An embodiment provides a method of verification of a matrix used for the signature of data using intermediate data generated during the generation of such a matrix.

An embodiment provides a method of verification, implemented by an electronic device, of a matrix used for the implementation of a data cipher algorithm comprising, for the generation of said matrix, the use of a first function and of a second function, said verification method comprising a verification using a final portion of the output data of said first function.

Another embodiment provides an electronic device adapted to implementing a method of verification of a matrix used for the implementation of a data cipher algorithm comprising, for the generation of said matrix, the use of a first function and of a second function, said verification method comprising a verification using a final portion of the output data of said first function.

According to an embodiment, the first function is a pseudo-random data generation function.

According to an embodiment, the first function comprises a third cryptographic hash function.

According to an embodiment, the third cryptographic hash function is the Keccak function.

According to an embodiment, said second function is a function of generation of polynomials based on pseudo-random data.

According to an embodiment, the data cipher algorithm is a lattice-based cryptography algorithm.

According to an embodiment, the data cipher algorithm is the algorithm known under denomination “Kyber”.

According to an embodiment, said matrix is the matrix A of said algorithm known under denomination “Kyber”.

According to an embodiment, said matrix is a context vector of said algorithm known under denomination “Kyber”.

According to an embodiment, the data cipher algorithm is the algorithm known under denomination “CRYSTALS-Dilithium”.

Another embodiment provides a data ciphering method adapted to implementing said data cipher algorithm, comprising the previously-described verification method.

Another embodiment provides a computer program-product adapted to implementing the previously-described verification method.

According to an embodiment, the computer program-product is adapted to implementing the previously-described ciphering method.

### BRIEF DESCRIPTION OF THE SEVERAL VIEWS OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows in the form of blocks an embodiment of an electronic device adapted to implementing the embodiments of FIGS. 2 to 4;

FIG. 2 schematically shows in the form of blocks an implementation mode of a data ciphering method;

FIG. 3 shows an implementation mode of a method of generation of a matrix of the method of FIG. 2 and an implementation mode of the method of verification of this generation; and

FIG. 4 shows the implementation of a function of the method of FIG. 3.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

The embodiments described hereafter concern the verification of the implementation of a data ciphering method, and more particularly the verification of the proper generation of a matrix used to implement a cipher algorithm used for this data ciphering method.

The matrices used by data cipher algorithms, like those of lattice-based cryptography algorithms, may be matrices of significant sizes, the storage of which is difficult. It is thus often decided to generate these matrices at the time of their use. In certain cases, this generation uses one or a plurality of pseudo-random data elements and one or a plurality of non-random data elements, such as, for example, meter data, and it should thus be verified that the generated matrix is conformable. The embodiments described in detail hereafter concern the implementation of a verification of a matrix generated by using a function of generation of polynomials based on pseudo-random data and a function of generation of pseudo-random data. The key point of these embodiments is to use a portion of the output data of the pseudo-random data generation function to perform this verification.

These embodiments more particularly apply to matrices of cipher algorithms known under denomination “CRYSTALS-Dilithium”, or known under denomination “Kyber”.

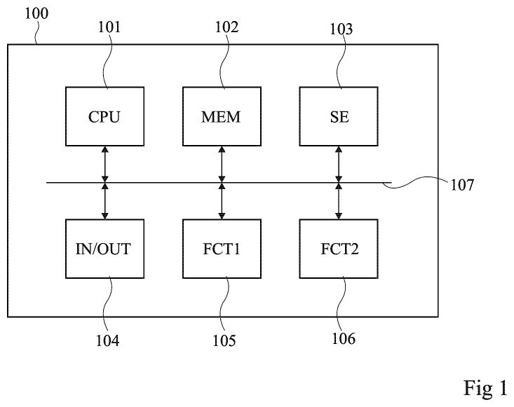

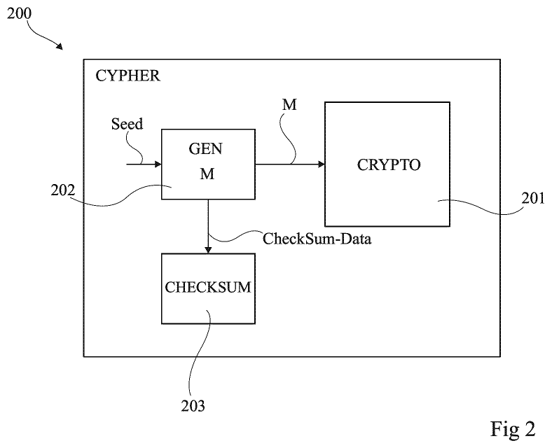

FIG. 1 is a block diagram very schematically showing an architecture of an example of an electronic device 100 adapted to executing the implementation mode of the matrix verification method described hereafter in relation with FIGS. 2 to 4.

Electronic device 100 comprises a processor 101 (CPU) adapted to implementing different operations of processing of data stored in memories and/or delivered by other circuits of device 100. According to an embodiment, processor 101 is adapted to implementing a data ciphering method using a verification method according to an embodiment.

Electronic device 100 further comprises different types of memories 102 (MEM), among which, for example, a non-volatile memory, a volatile memory, and/or a ROM. Each memory 102 is adapted to storing different types of data.

Electronic device 100 further comprises for example, a secure element 103 (SE) adapted to processing critical and/or secret data. Secure element 103 may comprise its own processor(s), its own memory or memories, etc. According to an embodiment, secure element 103 is adapted to implementing a data ciphering method using a verification method according to an embodiment.

Electronic device 100 may further comprise interface circuits 104 (IN/OUT) adapted to sending and/or to receiving data originating from the outside of device 100. Interface circuits 104 may further be adapted to implementing a data display, for example, a display screen.

Electronic device 100 further comprises different circuits 105 (FCT1) and 106 (FCT2) adapted to performing different functions. As an example, circuits 105 and 106 may comprise measurement circuits, data conversion circuits, etc.

Electronic device 100 further comprises one or a plurality of data buses 107 adapted to transferring data between its different components.

FIG. 2 very schematically shows, in the form of blocks, an implementation mode of a data ciphering method 200 (CYPHER).

Data ciphering method 200, or cipher method 200, enables to cipher data, or may enable to sign data.

Cipher method 200 comprises the implementation of an encryption algorithm 201 (CRYPTO). According to an embodiment, encryption algorithm 201 is lattice-based cryptography algorithm, such as, for example, the algorithm known under denomination “Kyber” or the algorithm known under denomination “CRYSTALS-Dilithium”. According to a preferred embodiment, encryption algorithm 201 is the algorithm known under denomination “Kyber”.

To be implemented, encryption algorithm 201 comprises the use of at least one matrix M generated by a matrix generation method 202 (GEN M) also forming part of cipher method 200. Generation method 202 takes, as an input, at least one seed data element. The generation method may use one or a plurality of generation algorithms and one or a plurality of generation functions to generate matrix M. According to a variant, generation method 202 may form part of encryption algorithm 201.

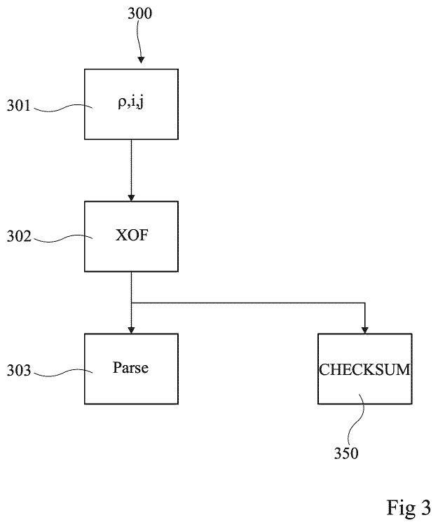

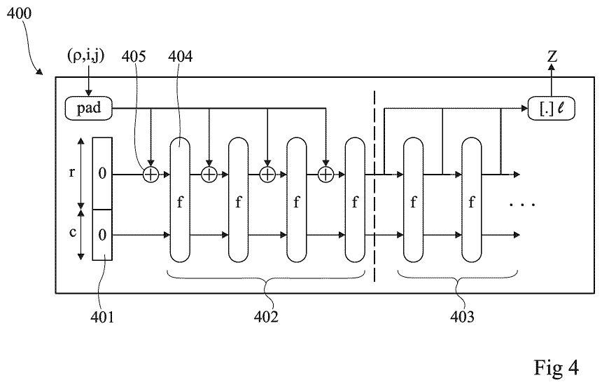

Cipher method 200 further comprises the implementation of an embodiment of a method of verification 203 (CHECKSUM) of the generation of said at least one matrix M, via a verification function. For this purpose, the verification method uses data CheckSum_Data supplied by generation function 202. The nature of data CheckSum_Data is described in relation with FIGS. 3 and 4.

According to the preferred embodiment, when the encryption algorithm is the algorithm known under denomination “Kyber”, generation method 202 is adapted to providing:
a public matrix A enabling to implement the algorithm; and
vectors SecretData representing secret data used by the algorithm.

Matrix A and vectors SecretData are all obtained by implementing generation method 202. Thus, verification function 203 is adapted to verifying the generation of matrix A and of vectors SecretData. According to a specific example, vectors SecretData may comprise four vectors s, e, r, and e2 representing secret data, and all having a size in the order of 256 coefficients each having a 12-bit size.

Cipher method 200 is adapted to being implemented by an electronic device of the type of the device 100 described in relation with FIG. 1, for example by its processor 101 or its secure element 103, or by a more complex electronic device such as a computer. The same applies for algorithm 201, generation method 202, and verification method 203. According to an embodiment, cipher method 200, algorithm 201, generation method 202, and verification method 203 may all be implemented by computer program-products.

FIG. 3 shows an implementation mode of a method of generation 300 of the type of the method 202 described in relation with FIG. 2 and an implementation mode of a method of verification 350 (CHECKSUM) of the type of the verification method 203 described in relation with FIG. 2.

In the previously-described preferred example, the encryption algorithm is the algorithm known under denomination “Kyber”, and the matrices to be generated are:
a public matrix A enabling to implement the algorithm; and
vectors SecretData representing secret data used by the algorithm.

Generation method 300 is used to generated one by one the coefficients m[i][j] of a matrix M comprising n rows and p columns, i being an integer in the range from 1 to n, and j being an integer in the range from 1 to p. Matrix M may correspond to matrix A or to vectors SecretData, such as the previously described vectors s, e, r, and e2. Generation method 300 enables to implement the following mathematical equation:

m[i][j]=Parse(XOF(ρ, i, j))

where:
Parse is a function of generation of polynomials of a known degree based on one or a plurality of pseudo-random data elements;
XOF is a function of generation of one or a plurality of pseudo-random data elements; and
ρ is a seed data element corresponding to the seed data element described in relation with FIG. 2.

In other words, the generation of matrix M follows the following steps.

At a step 301 (ρ,i,j), seed data element ρ, and index values i and j, are provided. According to a specific example, data element ρ is a 32-byte data element, that is, comprising 256 bits, and indexes i and j are 1-byte data, that is, comprising 8 bits.

At a step 302 (XOF), successive to step 301, function XOF of generation of one or a plurality of pseudo-random data is applied to data ρ, i, and j. According to an embodiment, the pseudo-random data delivered at the output of function XOF are of variable size. According to an example, function XOF is a sponge-type function enabling to create a hash function. A detailed example of a function of the type of function XOF is described in relation with FIG. 4.

At a step 303 (Parse), successive to step 302, function Parse of generation of polynomials of known degree based on pseudo-random data is applied to the pseudo-random data element(s) provided by function XOF. Since the pseudo-random output data element(s) of function XOF are of variable sizes, function Parse is adapted to taking as an input a data element of variable size to deliver as an output the polynomial of known degree. There exists a plurality of functions enabling to implement function Parse, two known functions are functions Parse and CBD. According to an example, function Parse is a function of selection by injection.

The output polynomial of function Parse forms an element of the matrix. It is then sufficient to repeat steps 301 to 303 as many times as necessary to have the full matrix M.

According to an embodiment, the generation of matrix A, and the generation of vectors SecretData may each individually use a different function Parse, a different function XOF, and a different seed data element ρ.

Thus, according to an embodiment, the elements mA[i][j] of matrix A are obtained by the implementation of the following mathematical equation:

mA[i][j]=ParseA(XOFA(ρA, i, j))

where:
ParseA is a function of generation of polynomials of known degree based on one or a plurality of pseudo-random data elements;
XOFA is a function of generation of one or a plurality of pseudo-random data elements; and
ρA is a seed data element corresponding to the seed data element described in relation with FIG. 2.

Thus, according to an embodiment, the elements mSD[i][j] of vectors SecretData are obtained by the implementation of the following mathematical equation:

mSD[i][j]=ParseSD(XOFSD(Seed(ρA, i, j)))

where:
ParseSD is a function of generation of polynomials of known degree based on one or a plurality of pseudo-random data elements;
XOFSD is a function of generation of one or a plurality of pseudo-random data elements;
Seed is a function of adaptation of seed data element ρA according to the desired output vector;
ρSD is a seed data element of matrix A corresponding to the seed data element described in relation with FIG. 2; and
in this case, index i is a nonce.

According to an embodiment, the verification method 350 associated with generation method 300 is the following. This method 350 implements a verification function Checksum, which is, for example, a function of verification by addition or checksum function. Function Checksum enables to verify that the matrix provided by generation method 300 is conformable. For this purpose, function Checksum takes, as input data, a portion of the output data of function XOF.

More particularly, and according to an embodiment, function Checksum takes as an input the last bits forming the output data element of function XOF, also called final portion of the output data element of function XOF. These last bits are dependent on all the previous operations, and in particular on seed data element ρ.

According to an embodiment, in the preferred case where the cipher algorithm is that known under denomination “Kyber”, and the generated elements are vectors SecretData, then the last bits used by function Checksum are the data bits of the output of function XOF which are not used by function Parse.

FIG. 4 shows a function 400 of the type of the function XOF described in relation with FIG. 3.

Function 400 is a sponge function enabling to construct cryptographic hash functions. As described in relation with FIG. 3, function 400 takes as an input the previously-described data ρ, i, and j, and output a pseudo-random data element Z. To operate, function 400 further receives as an input a data element to be hashed 401 formed of a data element r and of a data element c. Data element r is of same size as output data element Z. Data element c has a size which depends on the security level.

The function comprises two operating phases, a first absorption phase 402 followed by a second squeeze-out phase 403.

During absorption phase 402, a function 404 (f) is successively applied to data element 401, while periodically incorporating data ρ, i, and j. According to an embodiment, function 404 is a cryptographic hash function, like function Keccak. More particularly, data element r can be obtained by using the previously-described function Seed, having its result delivered as an input to function 404. Data element r, added to data element c, is also called “state” in literature. According to an example, data ρ, i, and j are only incorporated to data element r before the application of each function 404 via an XOR function. According to an embodiment, function 404 is applied between one and a plurality of times during phase 402.

During squeeze-out phase 403, function 404 (f) is successively applied to data element 401. According to an embodiment, function 404 is applied in the order of 4 times during phase 403. Output data element Z is equal to the combination of the output data of the functions 404 corresponding to the application of function 404 to data element r, generated by said function Seed.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

A method of verification (203; 350), implemented by an electronic device (100, 101, 103), of a matrix (M; A, e, s) used for the implementation of a data cipher algorithm (201) is summarized as including, for the generation of said matrix (M; A, e, s), the use of a first function (XOF) and of a second function (Parse), said verification method (350) comprising a verification using a final portion of the output data of said first function (XOF).

an electronic device (100, 101, 103) adapted to implementing a method of verification (203; 350) of a matrix (M; A, e, s) used for the implementation of a data cipher algorithm (201) is summarized as including, for the generation of said matrix (M; A, e, s), the use of a first function (XOF) and of a second function (Parse), said verification method (350) comprising a verification using a final portion of the output data of said first function (XOF).

The first function (XOF) is a pseudo-random data generation function.

The first function (XOF) includes a third cryptographic hash function (404).

The third cryptographic hash function (404) is the Keccak function.

Said second function (Parse) is a function of generation of polynomials based on pseudo-random data.

The data cipher algorithm (201) is a lattice-based cryptography algorithm.

The data cipher algorithm (201) is the “Kyber” algorithm.

Said matrix (A) is the matrix A of said “Kyber” algorithm.

Said matrix (s, e) is a context vector of said “Kyber” algorithm.

The data cipher algorithm (201) is the “CRYSTALS-Dilithium” algorithm.

A data ciphering method (200) adapted to implementing said data cipher algorithm (201), is summarized as including the verification method (203; 350) according to any of claims 1, 3 to 11.

A computer program-product is adapted to implementing the verification method (203; 350).

The computer program-product is adapted to implementing the ciphering method (200).

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
generating, in an electronic device, a matrix used for the implementation of a data cipher algorithm, the generating the matrix including:
providing a seed data element;
generating, with a first function, a first pseudo-random data element using the seed data element; and
generating, with a second function, a plurality of polynomials of a known degree based on the first pseudo-random data element; and
verifying, with a verification function using a final portion of output data of the first function, that the matrix is conformable.

2. The method according to claim 1, wherein the first function is a sponge-type function.

3. The method according to claim 2, wherein the first function comprises a third cryptographic hash function.

4. The method according to claim 3, wherein the third cryptographic hash function is a Keccak function.

5. The method according to claim 1, wherein the second function takes as an input a data element of a variable size and produces as an output the plurality of polynomials of the known degree.

6. The method according to claim 1, wherein the data cipher algorithm is a lattice-based cryptography algorithm.

7. The method according to claim 6, wherein the data cipher algorithm is the “Kyber” algorithm.

8. The method according to claim 7, wherein the matrix is the matrix A of the “Kyber” algorithm.

9. The method according to claim 7, wherein the matrix is a context vector of the “Kyber” algorithm.

10. The method according to claim 6, wherein the data cipher algorithm is the “CRYSTALS-Dilithium” algorithm.

11. The method according to claim 1, wherein the final portion of the output data of the first function includes a second pseudo-random data element that is not used by the second function.

12. A method, comprising:
generating a matrix for a data cipher algorithm, the generating the matrix including:
providing a seed data element and a plurality of index values;
generating, with a first, sponge-type function, a first pseudo-random data element using the seed data element and the plurality of index values;
generating, with a second function, a plurality of polynomials of a known degree based on the first pseudo-random data element; and
forming an element of the matrix with each of the plurality of polynomials; and
verifying, with a verification function using a final portion of output data of the first, sponge-type function, that the matrix is conformable.

13. The method according to claim 12, wherein the seed data element is a 32-byte data element comprising 256 bits.

14. The method according to claim 13, wherein the plurality of index values includes a first index value that is a 1-byte data element comprising 8 bits and a second index value that is a 1-byte data element comprising 8 bits.

15. The method according to claim 12, wherein the second function takes as an input a data element of a variable size and produces as an output the plurality of polynomials of the known degree.

16. The method according to claim 12, wherein the second function is a selection by injection type function.

17. A method, comprising:
generating a matrix for a data cipher algorithm, the generating the matrix including:
providing a seed data element and a plurality of index values;
generating, with a first, sponge-type function, a first pseudo-random data element using the seed data element and the plurality of index values, the generating a first pseudo-random data element including:
receiving a first data element to be hashed;
applying, during an absorption phase, a cryptographic hash function to the data element to be hashed; and
generating, during a squeeze-out phase, an output data element;
generating, with a second function, a plurality of polynomials of a known degree based on the first pseudo-random data element; and
forming an element of the matrix with each of the plurality of polynomials.

18. The method according to claim 17, wherein the cryptographic hash function is a Keccak function.

19. The method according to claim 17, wherein the cryptographic hash function is applied four times during the squeeze-out phase.

20. The method according to claim 17, further comprising:
forming the data element to be hashed from a first data element and a second data element, the first data element having a same size as the output data element and being generated by a seed function; and
incorporating, with an XOR function, the seed data element and the plurality of indices to the first data element before the applying the cryptographic hash function.
